(19) United States
(12) Patent Application Publication
(10) Pub. No.: US 2010/0000274 A1
(43) Pub. Date: Jan. 7, 2010

(54) ELECTRONIC BLOCKING MODULE FOR CLOSING SYSTEMS

(75) Inventors: Ana Viso Cabrera, Elgoibar (ES); Ramon Gabikagogeaskoa Sanchez, Elgoibar (ES); Beatriz Vierna Garcia, Elgoibar (ES)

Correspondence Address: MERCHANT & GOULD PC, P.O. BOX 2903, MINNEAPOLIS, MN, 55402-0903, US

(73) Assignee: OJMAR, S.A., Elgoibar (ES)

(21) Appl. No.: 12/178,749

(22) Filed: Jul. 24, 2008

(30) Foreign Application Priority Data
Jul. 2, 2008 (EP) 08380191.0

(51) Int. Cl. E05B 49/00

(52) U.S. Cl. 70/278.7

(57) ABSTRACT

The invention relates to an electronic blocking module for closing systems with a casing (1) internally having a blocking mechanism (2) which prevents or allows the opening of a closing system, and which is controlled by an electronics board (3), which communicates with an external electronic control system which transmits signals to it for blocking and unblocking the closing system, and receives from it signals of the position of the blocking mechanism (2). The electronics board (3) comprises at least a first microswitch (4) and a second microswitch (5) which detect the movement towards the blocking and unblocking position of the blocking mechanism (2), and a third microswitch (6) detecting the blocking and unblocking position of the blocking mechanism (2), transmitting it to the electronic control system.

### TECHNICAL FIELD OF THE INVENTION

The invention belongs to the technical field of closing systems, specifically those used in lockers, cupboards and drawers, and more specifically to electronic blocking systems of these closing systems which, by means of signals from the exterior, allow or prevent the opening of said closing systems.

### BACKGROUND OF THE INVENTION

There are currently a large number of locks, latches and closing systems in general controlled by an electronic blocking system which allows or prevents their opening, applied in lockers, cupboards, or office drawers.

These devices are generally carried out by means of electromechanical means consisting of an electronics board controlling mechanical means for blocking the closing system.

These devices have the drawback of how suitable control over the position and movement of the mechanical elements which block the closing system is performed so that the electronics board knows at which time it must give the order to commence the blocking movement, when to stop it and when to perform the unblocking movement.

A system attaining efficient control of the blocking mechanisms of closing systems of cupboards, lockers, drawers, etc., preventing the drawbacks existing in the previous systems in the state of the art, is therefore desired.

### SUMMARY OF THE INVENTION

The invention solves the problems existing in the state of the art by means of an electronic blocking module for closing systems for doors of lockers, cupboards, desks, chests of drawers, and similar storage elements.

This electronic module has a casing which internally houses a blocking mechanism which, in a blocking position, prevents the opening of a closing system, and in an unblocking position allows the opening of said closing system.

The blocking mechanism is controlled by an electronics board, which has microcontrollers, LEDs, microswitches, and the electronic components necessary for the actuation and control of the blocking mechanism.

The electronics board in turn communicates with an external electronic control system, which is what transmits to the electronics board the signals for blocking and unblocking the closing system, and receives from it signals of the position of the blocking mechanism. The electronics board can be reprogrammed to modify the operation of the blocking module.

In a particular embodiment of the invention, the blocking mechanism is formed by a motor controlled by the electronics board which, by means of a gear system, actuates a punch, which is the blocking element of the closing system itself, and arranges it in a blocking position in which the punch is placed against the closing system, blocking it and preventing the opening, or in an unblocking position in which the punch is separated from the closing system, unblocking it and allowing the opening.

In a region close to the blocking mechanism, the electronics board has at least a first microswitch detecting the movement of the blocking mechanism towards the blocking position, and a second microswitch detecting the movement of the blocking mechanism towards the unblocking position, and a third microswitch detecting the blocking and unblocking position of said blocking mechanism. These microswitches transmit the movement of the blocking mechanism and its blocking and unblocking positions of the closing system to the economic control system, for the processing and control of these data for the correct operation of the blocking module.

The signals that the electronics board of the control system receives for blocking and unblocking the closing system by means of the blocking mechanism are preferably pulses of a normally open relay arranged in the electronic control system.

Additionally, according to a preferred embodiment of the invention, the electronics board has a fourth microswitch, by means of which a timer is actuated, such that once the opening is allowed, by means of the timer the blocking mechanism remains in an unblocking position for a pre-established time, then automatically switching to a blocking position.

According to a particular embodiment of the invention, the control of the microswitches for detecting the movement and position of the blocking mechanism is carried out through the microcontroller of the actual electronics board. In contrast, according to an alternative embodiment of the invention, it is the external electronic control system which carries out control of the microswitches, i.e., the electronics board of the blocking module would carry out the control on the mechanical part, and the external electronic control system would control the correct operation of controlling the detection and movement of the microswitches.

### BRIEF DESCRIPTION OF THE DRAWINGS

An embodiment will be described below by way of an illustrative but non-limiting description in relation to a drawing.

FIG. 1 is a plan view of the blocking module of the invention according to a preferred embodiment.

The following set of elements is referred to in this drawing:

1. casing

2. blocking mechanism

3. electronics board

4. first microswitch

5. second microswitch

6. third microswitch

7. motor of the blocking mechanism

8. gear system of the blocking mechanism

9. punch of the blocking system

10. fourth microswitch

11. spring of the shaft of the punch

### DETAILED DESCRIPTION OF THE PREFERRED EMBODIMENTS

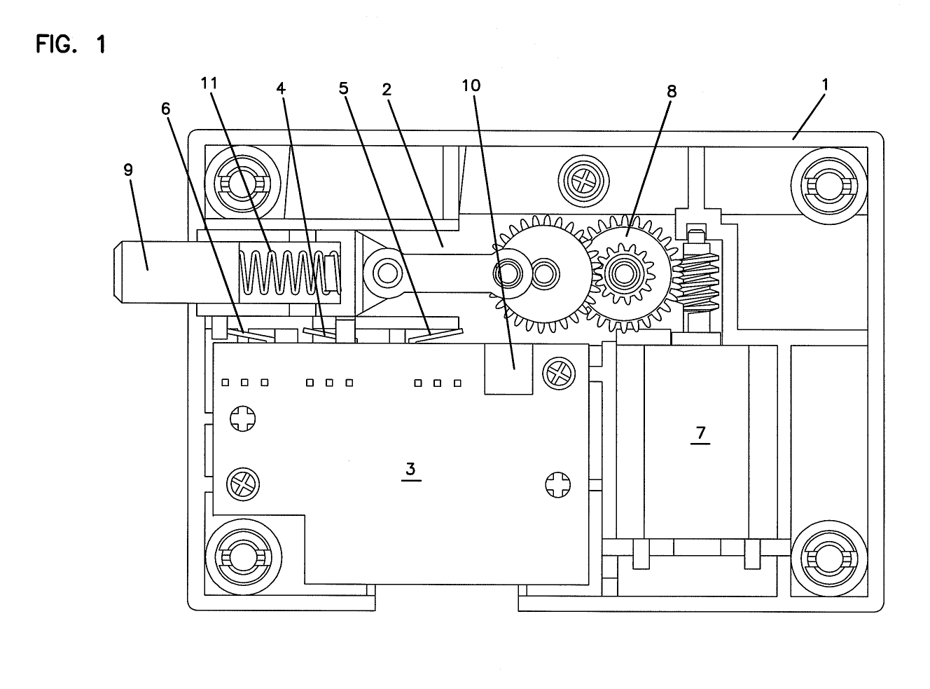

As shown in FIG. 1, the object of the invention is an electronic blocking module for closing systems of lockers, cupboards, drawers or the like, of the type of those having a casing internally housing a blocking mechanism 2, and an electronics board 3 controlling the blocking mechanism 2 such that in a blocking position, the blocking mechanism prevents the opening of a closing system, and in an unblocking position it allows the opening of said closing system.

In turn, the electronics board 3 communicates with an external electronic control system which transmits to the electronics board 3 the signals necessary to indicate the blocking and unblocking of the closing system, and receives from it signals indicating the position of the blocking mechanism 2 and its movement.

According to a preferred embodiment of the invention, these signals for carrying out the blocking and/or unblocking are pulses emitted by a normally open relay arranged in the external electronic control system.

The electronics board has at least a first microswitch 4 detecting the movement of the blocking mechanism 2 towards the blocking position, and a second microswitch 5 detecting the movement of the blocking mechanism 2 towards the unblocking position, and furthermore a third microswitch 6 which is what detects the position that the blocking mechanism is in, i.e., if it is blocking the closing system, or in contrast, if it has released the closing system, allowing the opening. These first, second and third microswitches 4,5,6 transmit to the external electronic control system the movement and positions of the blocking mechanism 2.

According to a preferred embodiment of the electronics board 3, the latter is reprogrammable to be able to act according to different operation modes.

The blocking mechanism 2 is preferably formed by a motor 7 controlled by the electronics board 3 which by means of a gear system 8 actuates a punch 9. In the blocking position this punch 9 is placed against the closing system and blocks it, preventing the opening. In contrast, in the unblocking position, the punch 9 is separated from the closing system, unblocking the latter and allowing the opening.

According to a preferred embodiment of the blocking mechanism 2, the latter has a spring which is arranged in the shaft of the punch 9, in contact with said punch, which allows it to carry out a recovery movement if it meets any obstacle in its travel, thus preventing possible jams of the blocking mechanism 2.

The electronic lock can be battery-powered, and according to a preferred embodiment of the invention, the electronics board 3 has a controller of the battery charge level, such that it prevents the movement of the blocking mechanism 2 to the blocking position of the closing system when this controller detects that the charge level is under a certain value to prevent the blocking module from being left without battery power while the blocking mechanism 2 is in the blocking position and the closing system cannot be opened.

According to a particular embodiment of the invention, the control of the different microswitches 4,5,6 for the detecting the movement and position of the blocking mechanism 2 can be carried out through the microcontroller arranged in the actual electronics board 3. According to an alternative embodiment of the invention, it is the external electronic control system which carries out the control of the microswitches 4,5,6, i.e., the electronics board 3 carries out the control over the mechanical part of the blocking module, and the external electronic control system controls the correct operation of controlling the detection and movement of the microswitches.

According to a preferred embodiment of the invention, the electronics board 3 additionally has a fourth microswitch 10 by means of which a timer is actuated from the exterior which, once the blocking mechanism 2 has reached its blocking position, makes it remain in said position during a pre-established time, to subsequently automatically return to the blocking position and prevent the opening of the closing system.

According to this preferred embodiment of the invention, when from the exterior a user carries out the opening by means of an opening pulse, the electronics board 3 activates the motor 7 of the blocking mechanism 2 to move the punch 9 to the unblocking position, and when it is detected in the unblocking position by the third switch 6, the electronics board 3 stops the motor 7. Once the predetermined time has passed, by means of the fourth microswitch 10 the closure is stopped, the electronics board activates the motor 7 again, which motor moves the punch 9 towards the blocking position, and when the third switch 6 detects that it has reached the blocking position, the electronics board 3 stops the motor 7 again.

Having clearly described the invention, it is hereby stated that the particular embodiments described above are susceptible to modifications of their details provided that such modifications do not alter the essential principle and essence of the invention.

1. An electronic blocking module for closing systems comprising
a casing, internally comprising
a blocking mechanism, which
in a blocking position prevents the opening of a closing system, and
in an unblocking position allows the opening of said closing system, and
an electronics board controlling the blocking mechanism, which communicates with
an external electronic control system which transmits to the electronics board signals for blocking and unblocking the closing system, and receives from it signals of the position of the blocking mechanism,
wherein the electronics board comprises, in the proximity of the blocking mechanism, at least
a first microswitch detecting the movement of the blocking mechanism towards the blocking position,
a second microswitch detecting the movement of the blocking mechanism towards the unblocking position,
and a third microswitch detecting the blocking and unblocking position of the blocking mechanism which transmit the movement and the positions of the blocking mechanism to the electronic control system.

2. The electronic blocking module for closing systems according to claim 1, wherein the signals for blocking and unblocking the closing system are pulses of a normally open relay arranged in the electronic control system.

3. The electronic blocking module for closing systems according to claim 1, wherein blocking mechanism comprises
a motor controlled by the electronics board, which actuates by means of
a gear system
a punch which in the blocking position is placed against the closing system, blocking the latter and preventing its opening, and in the unblocking position it is separated from said closing system, unblocking the latter and allowing its opening.

4. The electronic blocking module for closing systems according to claim 1, wherein the electronics board additionally comprises a fourth microswitch by means of which a timer is actuated from the exterior which, once the blocking mechanism has reached the unblocking position, makes it remain in said position during a pre-established time, and subsequently automatically return to the blocking position.

5. The electronic blocking module for closing systems according to claim 3, wherein the blocking mechanism comprises a spring arranged in the shaft of the punch in contact with said punch.

6. The electronic blocking module for closing systems according to claim 1, wherein the control of the first microswitch, of the second microswitch and of the third microswitch is carried out from the external electronic control system.

7. The electronic blocking module for closing systems according to claim 1, wherein the electronics board is reprogrammable according to different operation modes.

8. The electronic blocking module for closing systems according to claim 1, wherein it comprises a controller of the battery charge level arranged in the electronics board preventing the movement of the blocking mechanism to the blocking position when it detects that the charge level of said battery is under a certain level.
